(19) United States
(12) Patent Application Publication
(10) Pub. No.: US 2026/0004519 A1
(43) Pub. Date: Jan. 1, 2026

(54) AVATAR MODELING METHOD AND AVATAR MODELING SYSTEM

(71) Applicant: XRSPACE CO., LTD., Taoyuan City (TW)

(72) Inventors: Shih-Cheih CHOU, Taoyuan City (TW); Kai Ju CHEN, Taoyuan City (TW); Cheng Yu HSU, Taoyuan City (TW)

(21) Appl. No.: 19/254,024

(22) Filed: Jun. 30, 2025

Related U.S. Application Data
(60) Provisional application No. 63/666,233, filed on Jun. 30, 2024.

(51) Int. Cl. G06T 17/00

(52) U.S. Cl. CPC G06T 17/00

(57) ABSTRACT

An avatar modeling method includes steps of: extracting a foreground object from an input image; predicting a virtual skeleton for the foreground object, wherein the virtual skeleton comprises a plurality of skeleton nodes; adding a plurality of auxiliary virtual bones based on the plurality of skeleton nodes; segmenting the foreground object into a plurality of body part blocks based on the virtual skeleton and the plurality of auxiliary virtual bones; and associating the foreground object with the virtual skeleton according to a distribution of the plurality of body part blocks to convert the foreground object into an avatar.

### RELATED APPLICATIONS

This application claims the priority benefit of U.S. Provisional Application Ser. No. 63/666,233, filed Jun. 30, 2024, which is herein incorporated by reference.

### BACKGROUND

### Field of Invention

The present disclosure relates to a method and system for modeling an avatar. More specifically, the present disclosure relates to a modeling method and system that utilizes auxiliary virtual bones to facilitate the definition of body part blocks and improve segmentation accuracy.

### Description of Related Art

With the rise of social media and the concept of the metaverse, the technology for generating avatars from two-dimensional (2D) images has become a popular application. Conventional avatar modeling processes typically require a user to manually or semi-automatically define several skeleton nodes for a character in an image and then bind these nodes to corresponding body parts to establish a virtual skeleton for animation. However, this conventional method is not only tedious, time-consuming, and labor-intensive, but the resulting virtual skeleton is often only suitable for the specific body shape of a particular character. This leads to poor versatility, making it difficult to directly apply the skeleton to images of different body types or styles. Consequently, the virtual skeleton configuration must be readjusted each time the character is changed, resulting in a lack of efficiency.

Furthermore, when performing body part segmentation, conventional techniques rely solely on a limited number of skeleton nodes. As a result, when the avatar is in motion, imprecise segmentation often leads to unnatural deformations and visual artifacts between different body blocks. For example, the rotation of the head may pull and distort the neck block, or the movement of an arm may compromise the integrity of the torso. Moreover, for foreground objects with unusual poses (such as squatting or lying down) or non-standard humanoid forms, the accuracy of existing skeleton detection techniques significantly decreases, sometimes even producing chaotic results, thereby limiting their application scenarios. Therefore, there is an urgent need in the industry for an automated, high-precision avatar modeling solution that can handle diverse inputs to address the aforementioned problems of inaccurate segmentation and erroneous pose recognition.

### SUMMARY

An aspect of the present disclosure provides an avatar modeling method, which include steps of: extracting a foreground object from an input image; predicting a virtual skeleton corresponding to the foreground object, the virtual skeleton including a plurality of skeleton nodes; adding a plurality of auxiliary virtual bones based on the plurality of skeleton nodes; segmenting the foreground object into a plurality of body part blocks based on the virtual skeleton and the plurality of auxiliary virtual bones; and associating the foreground object with the virtual skeleton according to a distribution of the plurality of body part blocks, thereby converting the foreground object into an avatar.

An aspect of the present disclosure provides an avatar modeling system, which includes a communication interface, a storage unit, and a processor. The communication interface is configured to receive an input image. The storage unit is configured to store an object detection model and a pose estimation model. The processor is coupled to the communication interface and the storage unit. The processor is configured to: execute the object detection model to extract a foreground object from the input image; execute the pose estimation model to predict positions of skeleton nodes for the foreground object to generate a virtual skeleton; add a plurality of auxiliary virtual bones based on the plurality of skeleton nodes; segment the foreground object into a plurality of body part blocks based on the virtual skeleton and the plurality of auxiliary virtual bones; and associate the foreground object with the virtual skeleton according to a distribution of the plurality of body part blocks, thereby converting the foreground object into an avatar.

It is to be understood that the foregoing general description and the following detailed description are exemplary and explanatory only and are not restrictive of the invention, as claimed.

### BRIEF DESCRIPTION OF THE DRAWINGS

The disclosure can be more fully understood by reading the following detailed description of the embodiment, with reference made to the accompanying drawings as follows:

FIG. 1 is a functional block diagram illustrating an avatar modeling system according to an embodiment of the present disclosure;

FIG. 2 is a schematic diagram illustrating an input image received by a communication interface according to an embodiment;

FIG. 3 is a flowchart illustrating an avatar modeling method according to the present disclosure;

FIG. 4 is a schematic diagram illustrating an extracted foreground object and a predicted virtual skeleton according to some embodiments.

FIG. 5 is an enlarged schematic diagram of a virtual skeleton according to some embodiments;

FIG. 6 is a flowchart illustrating a method including further steps according to some embodiments;

FIG. 7 is a schematic diagram illustrating the positions of a plurality of auxiliary virtual bones added to a virtual skeleton;

FIG. 8 is a schematic diagram illustrating a block distribution of a foreground object segmented into a plurality of body part blocks based on a virtual skeleton without the addition of auxiliary virtual bones, according to an example;

FIG. 9 is a schematic diagram illustrating a block distribution of a foreground object segmented into a plurality of body part blocks based on a virtual skeleton with the addition of auxiliary virtual bones, according to some embodiments of the present disclosure;

FIG. 10 is a schematic diagram of an avatar generated according to some embodiments of the present disclosure;

FIG. 11 is a functional block diagram illustrating an avatar modeling system according to another embodiment of the present disclosure;

FIG. 12 is a flowchart illustrating an avatar modeling method according to the present disclosure;

FIG. 13 is a schematic diagram illustrating a pose of a virtual skeleton determined to have a correct distribution according to an embodiment; and

FIG. 14 is a schematic diagram illustrating a pose of a virtual skeleton determined to have an incorrect distribution according to another embodiment.

### DETAILED DESCRIPTION

The following disclosure provides many different embodiments, or examples, for implementing different features of the disclosure. Specific examples of components and arrangements are described below to simplify the present disclosure. Any examples discussed are for illustrative purposes only and are not intended to limit the scope and meaning of the disclosure or its examples in any way. Where appropriate, the same reference numerals are used in the drawings and the corresponding descriptions to refer to the same or like parts.

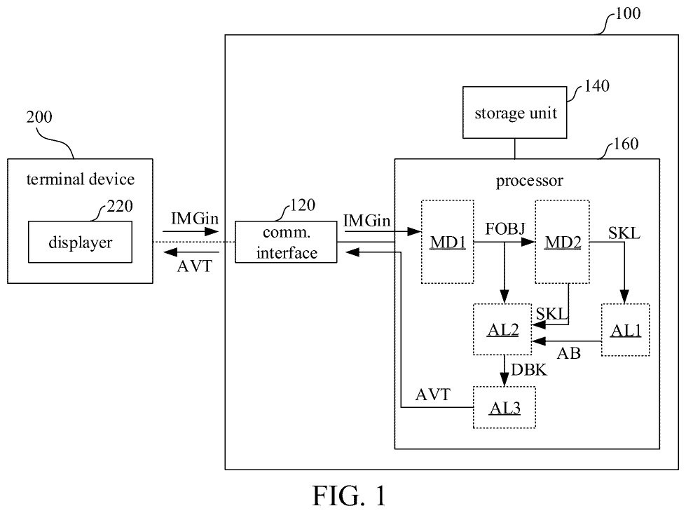

Reference is made to FIG. 1, which is a functional block diagram illustrating an avatar modeling system 100 according to some embodiments of present disclosure. In some embodiments, the avatar modeling system 100 includes a communication interface 120, a storage unit 140, and a processor 160. The processor 160 is coupled to the communication interface 120 and the storage unit 140.

In an embodiment, the communication interface 120 is configured to establish a communication connection with a terminal device 200. The communication interface 120 may include a signal connector (e.g., a USB connector), a network connector (e.g., an Ethernet connector or a fiber optic network connector), or a wireless communication transceiver circuit (e.g., a WiFi connector or a 5G communication network connector). The storage unit 140 may include a hard disk drive, flash memory, static random-access memory, dynamic random-access memory, registers, or cache memory. For example, the terminal device 200 may be a computing device operated by a user, such as a smartphone, a tablet computer, or a desktop computer.

With the growth of virtual worlds such as the metaverse, users often create avatars to represent themselves for interaction. Conventional avatar creation systems are often limited to a selection of pre-set templates, thereby failing to satisfy the user's desire for a unique and personalized avatar. To address this issue, the avatar modeling system 100 of the present disclosure enables a user to create a custom avatar from a user-provided input image IMGin. Accordingly, a user may operate a terminal device 200 to transmit a desired input image IMGin to the avatar modeling system 100 for creating the virtual character.

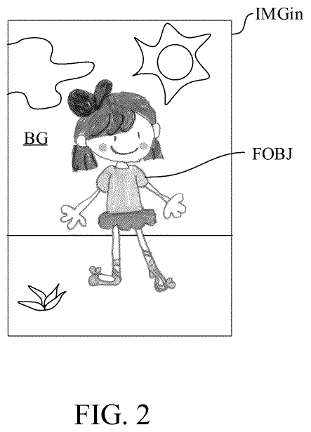

Reference is further made to FIG. 2, which is a schematic diagram illustrating an input image IMGin received by the communication interface 120 in one embodiment. As shown in FIG. 2, the input image IMGin includes a foreground object FOBJ to be converted into an avatar. After the communication interface 120 receives the input image IMGin, it transmits the input image IMGin to the processor 160.

Referring to the embodiment of FIG. 2, the input image IMGin provided by the user comprises a background BG (e.g., grass and sky) and a foreground object FOBJ. In this example, the foreground object FOBJ is a cartoon-style little girl, which represents the character the user intends to convert into an avatar for use in a virtual world.

By performing a sequence of modeling operations, the processor 160 converts the foreground object FOBJ into an avatar AVT. The processor 160 extracts the foreground object FOBJ from the input image IMGin, segments it into several body part blocks, and then links these blocks to a virtual skeleton, thereby creating an animatable avatar AVT capable of performing various actions.

After the modeling is complete, the avatar AVT output by the processor 160 can be used for subsequent animation or display applications. For example, it can represent the user for social interactions in a virtual scene. Furthermore, the completed avatar AVT can also be transmitted through the communication interface 120 back to the terminal device 200, and to be displayed on a display 220 of the terminal device 200. The detailed method by which the processor 160 creates the avatar AVT based on the input image IMGin will be further described in the following paragraphs.

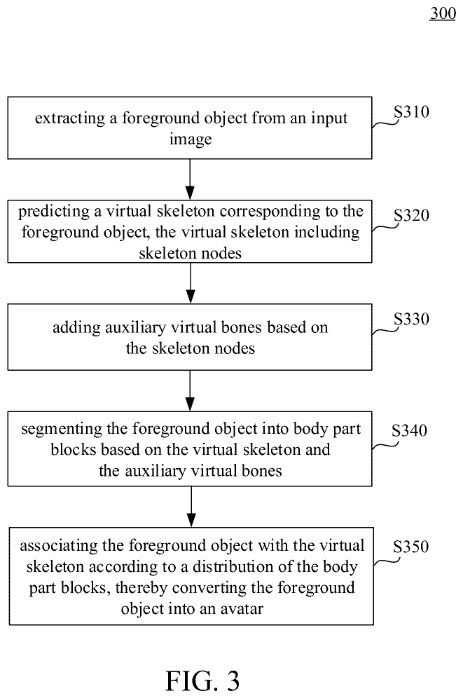

Reference is further made to FIG. 3, which is a flowchart illustrating an avatar modeling method 300 according to present disclosure. The avatar modeling method 300 can be executed by the avatar modeling system 100 in FIG. 1.

The avatar modeling method 300 executes step S310, extracting the foreground object FOBJ from the input image IMGin. The processor 160 is configured to execute an object detection model MD1 to extract the foreground object FOBJ from the input image IMGin.

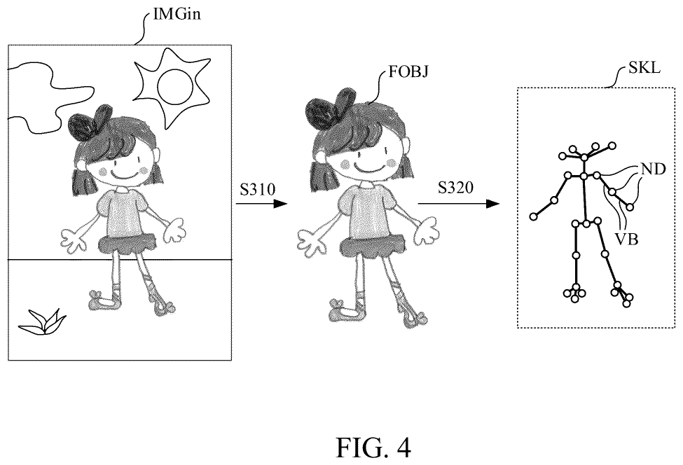

Reference is further made to FIG. 4, which is a schematic diagram illustrating the foreground object FOBJ extracted in step S310 and the virtual skeleton SKL predicted in step S320 in some embodiments.

In one embodiment, in step S310, the object detection model MD1 scans the input image IMGin and identifies a salient object therein. For the identified salient object, the object detection model MD1 may create a mask to define the boundary position of the salient object. After the mask is created, it can be used to filter out the background BG portion of the input image IMGin, retaining the image data of the salient object, thereby extracting the foreground object FOBJ, as shown in FIG. 4.

In one embodiment, the object detection model MD1 can be implemented by a Region-based Convolutional Neural Network (R-CNN) model, a YOLO model, a U-Net model, or a Segment Anything Model (SAM). In one embodiment, parameters of the object detection model MD1 can be stored in the storage unit 140 and the object detection model MD1 can be executed by the processor 160.

Afterward, in step S320, the processor 160 executes a pose estimation model MD2 to predict a virtual skeleton SKL for the foreground object FOBJ. As shown in FIG. 4, the virtual skeleton SKL includes multiple skeleton nodes ND and virtual bones VB connecting these skeleton nodes.

As shown in FIG. 4, the skeleton nodes ND in the predicted virtual skeleton SKL correspond to feature points of the foreground object FOBJ (i.e., the cartoon little girl). For example, the positions of these skeleton nodes ND include the nose, eyes, ears, shoulders, chest, elbows, wrists, hips, pelvis midpoint, knees, and ankles of the foreground object FOBJ. The virtual skeleton SKL also includes virtual bones VB connecting these skeleton nodes ND.

In some embodiments, the pose estimation model MD2 can be implemented by an OpenPose model, a High-Resolution Network (HRNet) model, or a transformer-based pose recognition model. In one embodiment, parameters of the pose estimation model MD2 can be stored in the storage unit 140 and the pose estimation model MD2 can be executed by the processor 160.

The OpenPose model, for instance, operates by detecting all joint nodes in the foreground object FOBJ and subsequently connecting them into a character's skeleton using Part Affinity Fields (PAFs). The HRNet model, on the other hand, predicts the overall skeleton and then pinpoints the joint nodes. To achieve high accuracy, HRNet maintains high-resolution feature maps throughout its prediction pipeline to prevent information loss. Transformer-based pose recognition models treat pose estimation as a set prediction problem, allowing for the direct, end-to-end output of a complete skeleton prediction.

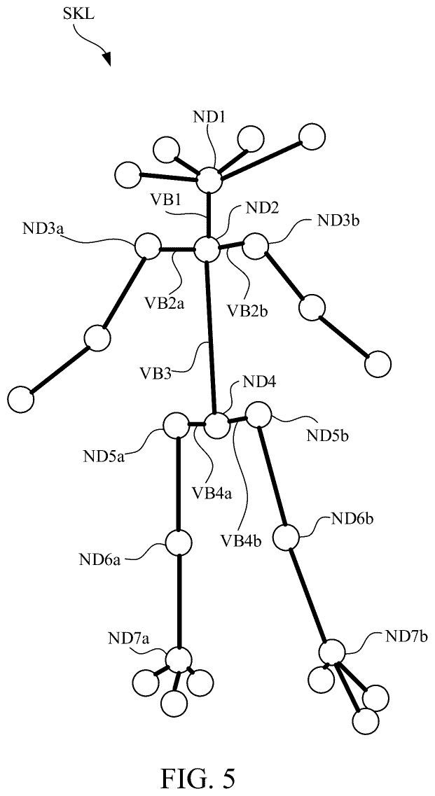

Reference is further made to FIG. 5, which is a schematic diagram illustrating an enlarged view of the virtual skeleton SKL in some embodiments. As shown in FIG. 5, the virtual skeleton SKL includes a nose node ND1, a chest node ND2, a first shoulder node ND3a, a second shoulder node ND3b, a pelvis midpoint ND4, a first hip node ND5a, a second hip node ND5b, a first knee node ND6a, a second knee node ND6b, a first ankle node ND7a, and a second ankle node ND7b. It should be noted that the number of skeleton nodes in the virtual skeleton SKL is not limited to the embodiment shown in FIG. 5.

In practical applications, enabling the generated avatar AVT to perform various actions (such as nodding, waving, walking, and dancing) requires various movable joints defined on the avatar AVT. A greater number of movable joints allows the avatar AVT to execute a wider variety of actions with more flexibility, producing more natural and fluid animation. The virtual skeleton SKL shown in FIG. 5 illustrates a configuration that includes major movable joints. For practical applications, a more complex skeleton containing more joint nodes can be designed to achieve finer motion control. Conversely, to reduce the computational load or increase processing speed, the virtual skeleton SKL can be streamlined by reducing the number of its joint nodes.

As shown in FIG. 5, the virtual skeleton SKL further includes a virtual cervical vertebra VB1 (located between the nose node ND1 and the chest node ND2), a first virtual shoulder blade VB2a (located between the first shoulder node ND3a and the chest node ND2), a second virtual shoulder blade (located between the second shoulder node ND3b and the chest node ND2), a virtual spinal bone VB3 (located between the chest node ND2 and the pelvis midpoint ND4), a first virtual hip bone VB4a (located between the first hip node ND5a and the pelvis midpoint ND4), and a second virtual hip bone VB4b (located between the second hip node ND5b and the pelvis midpoint ND4).

Afterward, in step S330, the processor 160 executes a first algorithm AL1 to add several auxiliary virtual bones AB based on the virtual skeleton SKL and the positions of the skeleton nodes within the virtual skeleton SKL.

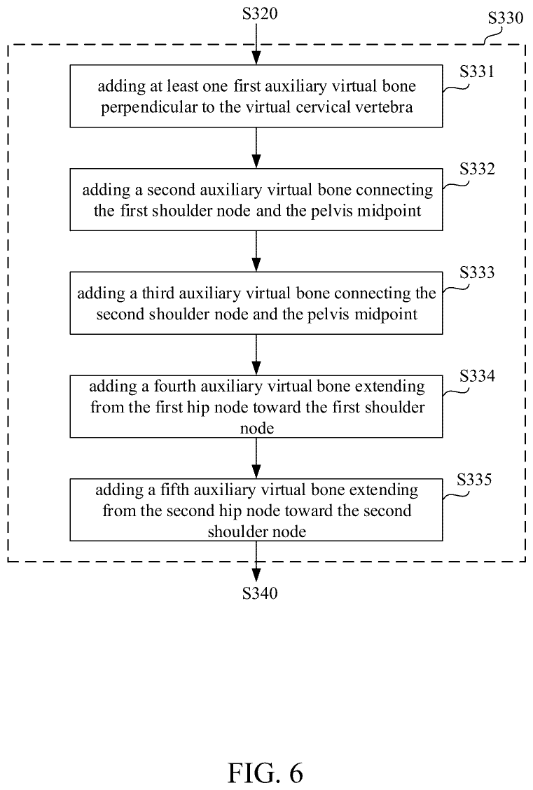

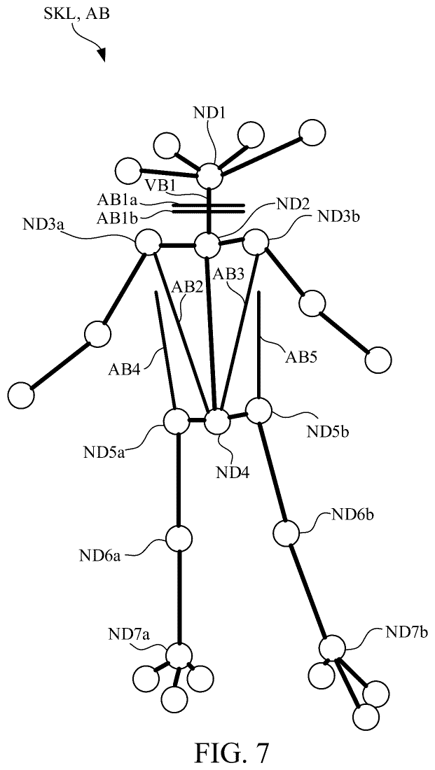

Reference is further made to FIG. 6 and FIG. 7. FIG. 6 is a flowchart illustrating some steps S331-S335 included in aforesaid step S330 according to some embodiments. FIG. 7 is a schematic diagram illustrating the positions of the virtual skeleton SKL and the auxiliary virtual bones AB added in step S330.

In one embodiment, the first algorithm AL1 for adding auxiliary virtual bones can be implemented by steps S331-S335 as shown in FIG. 6.

As shown in FIG. 6, the processor 160 executes step S331, adding at least one first auxiliary virtual bone perpendicular to the virtual cervical vertebra VB1 in the virtual skeleton SKL. In the embodiment of FIG. 7, step S331 involves adding two first auxiliary virtual bones AB1a and AB1b at two different positions around a mid-section of the virtual cervical vertebra VB1, along the direction perpendicular to the virtual cervical vertebra VB1. The number of the first auxiliary virtual bones AB1a and AB1b is not limited to two; one or more can be added in practical applications.

The virtual cervical vertebra VB1 is located between the nose node ND1 and the chest node ND2, and the two first auxiliary virtual bones AB1a and AB1b are two transverse auxiliary virtual bones added approximately around the throat area.

Afterward, step S332 is executed to add a second auxiliary virtual bone AB2 to the virtual skeleton SKL. As shown in FIG. 7, the second auxiliary virtual bone AB2 connects the first shoulder node ND3a to the pelvis midpoint ND4.

Afterward, step S333 is executed to add a third auxiliary virtual bone AB3 to the virtual skeleton SKL. As shown in FIG. 7, the third auxiliary virtual bone AB3 connects the second shoulder node ND3b to the pelvis midpoint ND4.

Afterward, step S334 is executed to add a fourth auxiliary virtual bone AB4 to the virtual skeleton SKL. As shown in FIG. 7, the fourth auxiliary virtual bone AB4 originates from the first hip node ND5a and extends toward the first shoulder node ND3a. In the embodiment of FIG. 7, the fourth auxiliary virtual bone AB4 is not directly connected to the first shoulder node ND3a.

Afterward, step S335 is executed to add a fifth auxiliary virtual bone AB5 to the virtual skeleton SKL. As shown in FIG. 7, the fifth auxiliary virtual bone AB5 originates from the second hip node ND5b and extends toward the second shoulder node ND3b. In the embodiment of FIG. 7, the fifth auxiliary virtual bone AB5 is not directly connected to the second shoulder node ND3b.

It should be noted that the first auxiliary virtual bones AB1a and AB1b, the second auxiliary virtual bone AB2, the third auxiliary virtual bone AB3, the fourth auxiliary virtual bone AB4, and the fifth auxiliary virtual bone AB5 added here are not part of the virtual skeleton SKL predicted by the pose estimation model MD2, nor do they directly correspond to the positions of real anatomical bones in the human body. These auxiliary virtual bones AB are added here for the segmentation accuracy of the foreground object in subsequent steps. In other words, the various auxiliary virtual bones AB described above have no direct correspondence with real human bones and are not directly related to the joint movements of the avatar AVT.

As shown in FIG. 1 and FIG. 3, step S340 is executed, wherein the processor 160 executes a second algorithm AL2 to segment the foreground object FOBJ into body part blocks based on the virtual skeleton SKL and the auxiliary virtual bones AB (as shown in FIG. 7).

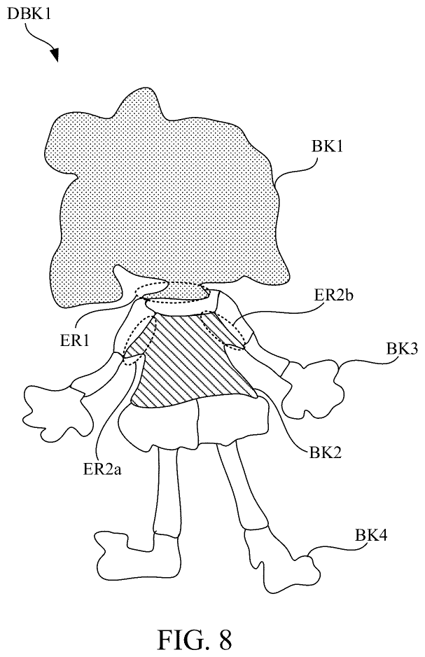

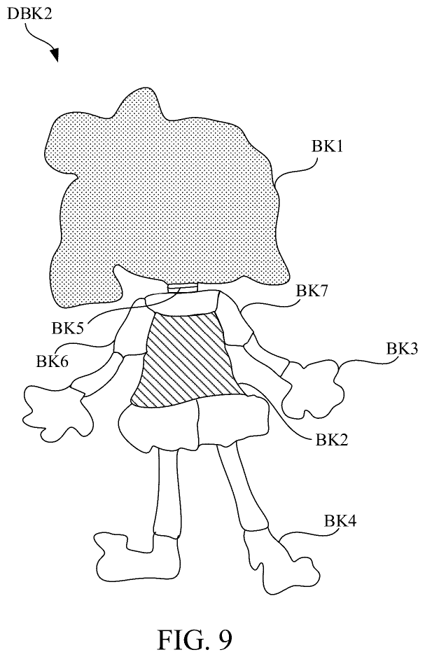

Reference is further made to FIG. 8 and FIG. 9. FIG. 8 is a schematic diagram illustrating a block distribution DBK1 of the foreground object FOBJ segmented into several body part blocks according to the virtual skeleton SKL without adding auxiliary virtual bones in one example. FIG. 9 is a schematic diagram illustrating another block distribution DBK2 of the foreground object FOBJ segmented into several body part blocks according to the virtual skeleton SKL with the addition of auxiliary virtual bones AB in some embodiments of the present disclosure.

In some embodiments, the segmentation approach of the second algorithm AL2 defines a boundary of one of the body part blocks by expanding outward from a starting skeleton node of the virtual skeleton SKL until encountering another skeleton node of the virtual skeleton SKL or any auxiliary virtual bone AB.

For example, as shown in FIG. 8 and FIG. 9, the pelvis midpoint ND4 can be used as a starting skeleton node to expand outward to the torso, thereby obtaining the boundary of body part block BK2. By analogy, the boundaries of various body part blocks can be obtained, such as body part block BK1 representing the head, body part block BK3 representing the left hand, and body part block BK4 representing the left foot.

It should be noted that in the example of FIG. 8, because no auxiliary virtual bones are added, the original virtual skeleton SKL lacks a transverse bone in the middle of the neck to clearly distinguish the head from the chest. Therefore, when segmenting the blocks according to the aforementioned expansion method, it is highly possible to segment chin, neck, and even a part of the shoulder clavicle position into the body part block BK1 representing the head. As shown in FIG. 8, the body part block BK1 includes an incorrect segmentation region ER1.

Assuming the segmentation result is as shown in FIG. 8, when the subsequently generated avatar performs actions such as nodding, turning its head, or raising its head, it will incorrectly affect the chin, neck, and even a part of the shoulder clavicle (i.e., the incorrect segmentation position ER1). This will cause the avatar to exhibit visual artifacts, body part distortion, or unnatural movements.

Similarly, in the example of FIG. 8, because no auxiliary virtual bones are added, there is no clear boundary between the torso and the arms in the original virtual skeleton SKL. Therefore, when segmenting blocks according to the aforementioned expansion method, it is highly possible to segment a part of the arm near the armpit into the body part block BK2 representing the torso. As shown in FIG. 8, the body part block BK2 includes the incorrect segmentation region ER2.

Assuming the segmentation result is as shown in FIG. 8, when the subsequently generated avatar performs actions related to the arms, such as raising a hand, waving, or swinging an arm, the incorrect segmentation position ER2 will not be able to move normally with the arm. On the other hand, when the subsequently generated avatar performs actions related to the torso, such as turning or bending over, it will incorrectly affect the incorrect segmentation position ER2. This will cause the avatar to exhibit visual artifacts, body part distortion, or unnatural movements.

On the other hand, as shown in FIG. 7 and FIG. 9, after adding the first auxiliary virtual bones AB1a and AB1b, the first auxiliary virtual bones AB1a and AB1b are configured to facilitate a correct segmentation between the body part block BK1 representing the head and the body part block BK5 representing the neck, to prevent shape distortion of the head and neck blocks when the avatar is in motion.

Similarly, as shown in FIG. 7 and FIG. 9, after adding the second auxiliary virtual bone AB2, the third auxiliary virtual bone AB3, the fourth auxiliary virtual bone AB4, and the fifth auxiliary virtual bone AB5, the aforementioned auxiliary virtual bones are configured to facilitate a correct segmentation between the body part block BK2 representing the torso, the body part block BK6 representing the right arm, and the body part block BK7 representing the left arm. This can prevent shape distortion of the torso when the right or left arm is in motion. Similarly, it can also prevent shape distortion of the right or left arm when the torso is in motion.

As shown in FIG. 1 and FIG. 3, in step S350, the processor 160 executes a third algorithm AL3 to associate the foreground object FOBJ with the virtual skeleton SKL according to the block distribution DBK2 of the body part blocks shown in FIG. 9, thereby converting the foreground object FOBJ into an avatar AVT.

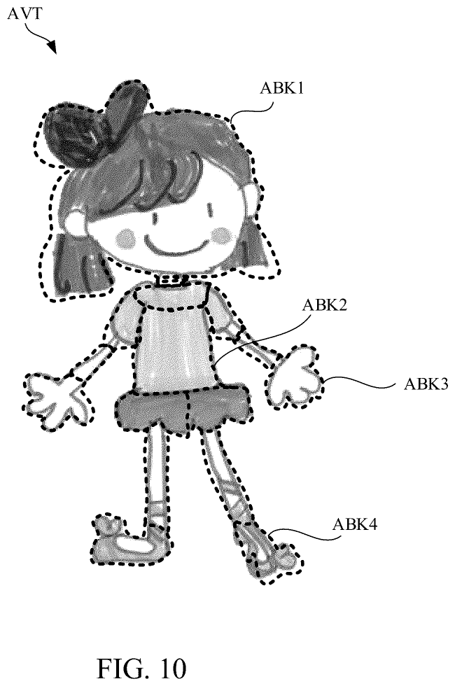

Reference is further made to FIG. 10, which is a schematic diagram illustrating an avatar AVT generated according to some embodiments of the present disclosure. As shown in FIG. 10, the avatar AVT includes avatar blocks, for example, avatar blocks ABK1-ABK4. The segmentation of the avatar blocks is based on the block distribution DBK2 of the body part blocks shown in FIG. 9. That is, the avatar blocks ABK1-ABK4 in FIG. 10 correspond to the body part blocks BK1-BK4 representing the head, torso, left hand, and left foot in FIG. 9, respectively.

After the avatar AVT is modeled in step S350, the different avatar blocks ABK1-ABK4 of the avatar AVT can be driven by the virtual skeleton SKL to perform different actions.

In response to that the avatar AVT is in motion, an avatar block corresponding to one body part block will move or rotate as a single unit. For example, when the avatar AVT waves its left hand, the avatar block ABK3 (corresponding to the left hand) itself will move synchronously as a single unit. At the same time, when waving the left hand, the avatar block ABK3 can move or rotate relative to different avatar blocks corresponding to different body part blocks (e.g., the avatar block ABK1 corresponding to the head, the avatar block ABK2 corresponding to the torso). In this way, the avatar AVT can perform and present various different actions and poses.

In summary, the avatar modeling system 100 and the avatar modeling method 300 provided by the present disclosure can automatically convert any two-dimensional image provided by a user into a high-quality, animatable avatar by performing a series of steps including foreground object extraction (step S310), virtual skeleton prediction (step S320), adding auxiliary virtual bones (step S330), body part block segmentation (step S340), and model association (step S350). In particular, this embodiment significantly improves segmentation accuracy by additionally adding auxiliary virtual bones to the virtual skeleton. These auxiliary bones are unrelated to real anatomical bones and are specifically designed for segmentation of body part blocks (e.g., head, neck, torso, and arms). The above-described embodiment helps to solve the technical problem of unnatural deformation, distortion, or visual artifacts when the avatar performs actions such as nodding or waving due to ambiguous segmentation boundaries. Therefore, the avatar modeling system 100 and the avatar modeling method 300 not only simplify the avatar creation process and meet the personalized needs of users, but also ensure that the finally generated avatar has higher realism and visual fluidity in its dynamic performance, thereby greatly enhancing the user's immersive experience in the metaverse or various virtual interactive scenes.

In the aforementioned embodiments, the virtual skeleton prediction in step S320 is automated through the pose estimation model MD2. However, in practical applications, user-provided input images IMGin can be highly diverse, encompassing types such as cartoon humans, cartoon animals, real human portraits, real animals, or even abstract anthropomorphic characters. Due to this diversity, it is challenging to consistently ensure high accuracy for the virtual skeleton SKL when it is automatically predicted by the pose estimation model MD2. Therefore, some embodiments of the present disclosure introduce a correctness detection and automatic debugging mechanism for the virtual skeleton SKL.

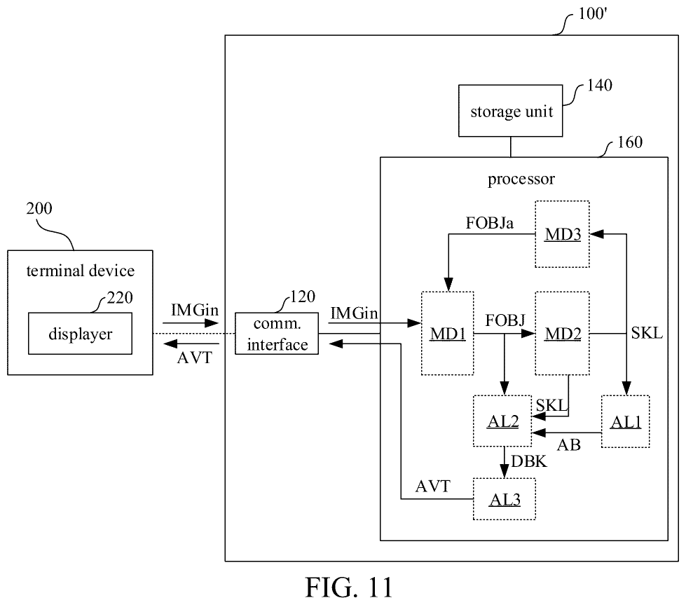

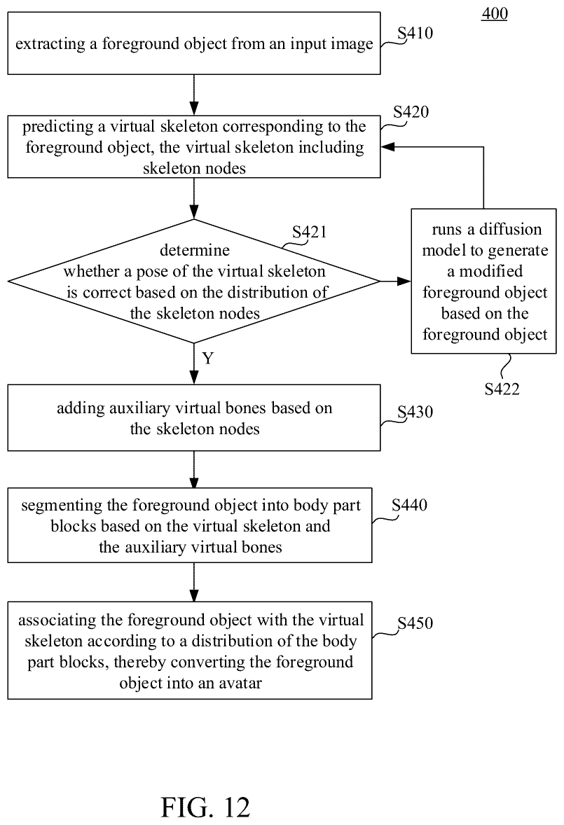

Reference is further made to FIG. 11 and FIG. 12. FIG. 11 is a functional block diagram illustrating an avatar modeling system 100′ according to another embodiment of the present disclosure. FIG. 12 is a flowchart illustrating an avatar modeling method 400 according to the present disclosure. The avatar modeling system 100′ shown in FIG. 11 can be used to execute the avatar modeling method 400 shown in FIG. 12.

The avatar modeling method 400 shown in FIG. 12 includes steps S410, S420, S430, S440, and S450, which are similar to steps S310, S320, S330, S340, and S350 in the avatar modeling method 300 shown in FIG. 3, and thus will not be described again here.

Compared to the avatar modeling method 300 shown in FIG. 3, the difference is that the avatar modeling method 400 shown in FIG. 12 further includes step S421 and step S422.

In step S420, the processor 160 executes the pose estimation model MD2 to predict a virtual skeleton SKL for the foreground object FOBJ. As shown in FIG. 4, the virtual skeleton SKL includes several skeleton nodes ND and several virtual bones VB connecting these skeleton nodes.

As shown in FIG. 12, after the virtual skeleton SKL is predicted in step S420, step S421 is further executed to determine whether the pose of the generated virtual skeleton SKL is correct based on the distribution of the skeleton nodes ND in the virtual skeleton SKL.

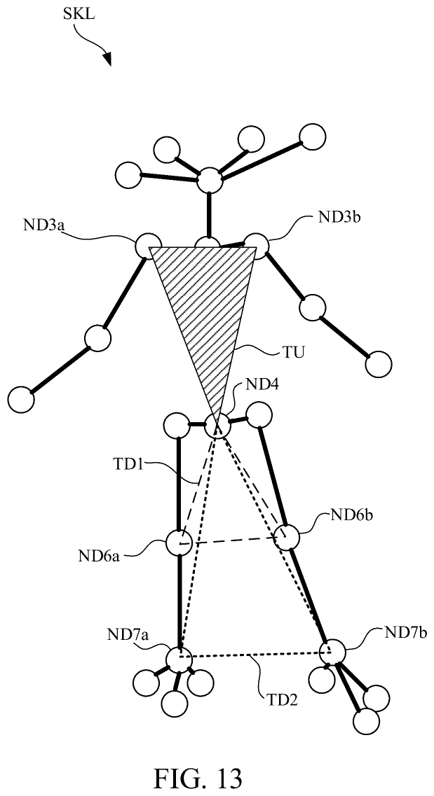

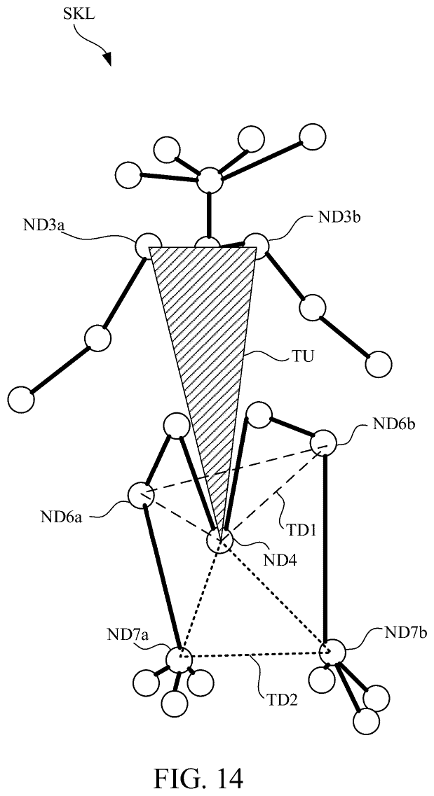

Reference is further made to FIG. 13 and FIG. 14. FIG. 13 is a schematic diagram illustrating a pose of the virtual skeleton SKL determined to have a correct distribution in one embodiment. FIG. 14 is a schematic diagram illustrating another pose of the virtual skeleton SKL determined to have an incorrect distribution in another embodiment.

In one embodiment, step S421 determines whether the pose of the virtual skeleton SKL is correct by checking whether an upper body triangle and at least one lower body triangle formed by the virtual skeleton SKL overlap.

As shown in FIG. 13, the first shoulder node ND3a, the second shoulder node ND3b, and the pelvis midpoint ND4 of the virtual skeleton SKL define an upper body triangle TU. The pelvis midpoint ND4, the first knee node ND6a, and the second knee node ND6b of the virtual skeleton SKL define a first lower body triangle TD1. The pelvis midpoint ND4, the first ankle node ND7a, and the second ankle node ND7b of the virtual skeleton SKL define a second lower body triangle TD2.

In the embodiment of FIG. 13, the upper body triangle TU and the first lower body triangle TD1 do not overlap. Furthermore, the upper body triangle TU and the second lower body triangle TD2 also do not overlap. This indicates that the virtual skeleton SKL shown in FIG. 13 has not undergone excessive deviation, excessive torsion, or abnormal conditions, whereby it can be determined that the virtual skeleton SKL shown in FIG. 13 has a correct pose.

If step S421 determines that the virtual skeleton SKL has a correct pose, the subsequent steps S430-S450 can be continued to generate the avatar AVT.

On the other hand, as shown in FIG. 14, the first shoulder node ND3a, the second shoulder node ND3b, and the pelvis midpoint ND4 of the virtual skeleton SKL define an upper body triangle TU. The pelvis midpoint ND4, the first knee node ND6a, and the second knee node ND6b of the virtual skeleton SKL define a first lower body triangle TD1. The pelvis midpoint ND4, the first ankle node ND7a, and the second ankle node ND7b of the virtual skeleton SKL define a second lower body triangle TD2.

In the embodiment of FIG. 14, the upper body triangle TU and the first lower body triangle TD1 overlap. This may indicate that some nodes in the virtual skeleton SKL shown in FIG. 14 have undergone excessive deviation, excessive torsion, or abnormal conditions, whereby it can be determined that the virtual skeleton SKL shown in FIG. 14 has an incorrect pose. If the subsequent steps of adding auxiliary virtual bones, segmenting body part blocks, and model association are continued based on the virtual skeleton SKL shown in FIG. 14, it may lead to significant distortion or unnatural movements in the final avatar AVT.

If step S421 determines that the virtual skeleton SKL has an incorrect pose, step S422 can be executed, wherein the processor 160 runs a diffusion model MD3 to generate a modified foreground object FOBJa based on the foreground object FOBJ.

In some embodiments, the diffusion model MD3 is primarily used to regenerate the foreground object for the purpose of correcting an incorrect virtual skeleton pose. This is especially useful for non-humanoid objects or for foreground objects FOBJ that have abnormal poses. The diffusion model MD3 is configured to regenerate the modified foreground object FOBJa so that it is human-like and adopts a standardized pose, such as facing forward with arms hanging down naturally. This diffusion model MD3 can be implemented using a stable diffusion model. Accordingly, the foreground object FOBJ, having been identified as having an incorrect pose, can be input to the stable diffusion model, which is then prompted to generate a modified foreground object FOBJa that retains the original shape but features a corrected pose.

Then, step S420 is executed again, wherein the processor 160 re-executes the pose estimation model MD2 based on the modified foreground object FOBJa to predict several modified skeleton nodes for the modified foreground object FOBJa to regenerate a modified virtual skeleton.

Step S421 is executed again based on the modified virtual skeleton, and once the modified virtual skeleton is determined to have a correct pose, the subsequent steps S430-S450 can be continued to generate the avatar AVT.

In summary, the present disclosure reveals an avatar modeling method and system that includes an automated debugging mechanism. This embodiment aims to solve the problem of insufficient accuracy in the initial predicted virtual skeleton due to the diversity of input image types (e.g., non-humanoid or with peculiar poses). In the above-described embodiment, after generating the initial virtual skeleton, a correctness determination step S421 is introduced, which automatically identifies a virtual skeleton with an incorrect pose by detecting whether there is an unreasonable overlap between geometric triangles formed by key upper and lower body parts.

Once an error is detected, this embodiment will initiate a pose correction step S422, using a diffusion model MD3 to intelligently generate a modified foreground object with a standardized pose (e.g., standing front-facing) based on the original foreground object. Next, the system re-performs skeleton prediction on this modified object, forming a closed-loop correction process of “predict-determine-modify.” This mechanism ensures that subsequent modeling steps (such as adding auxiliary bones, segmenting blocks) are based on an accurate and reliable virtual skeleton, thereby fundamentally avoiding the problem of severe distortion or abnormal movements in the final avatar caused by an initial skeleton error. Therefore, this embodiment not only improves the robustness of the modeling process but also significantly expands the applicability and versatility of this technology to various complex and non-standard input images.

Although specific embodiments of the disclosure have been disclosed, these embodiments are not intended to be limiting. Various substitutions and modifications can be made by those of ordinary skill in the art without departing from the principles and spirit of the disclosure. Therefore, the scope of protection of the disclosure is determined by the appended claims.

What is claimed is:

1. An avatar modeling method, comprising:
extracting a foreground object from an input image;
predicting a virtual skeleton corresponding to the foreground object, the virtual skeleton comprising a plurality of skeleton nodes;
adding a plurality of auxiliary virtual bones based on the plurality of skeleton nodes;
segmenting the foreground object into a plurality of body part blocks based on the virtual skeleton and the plurality of auxiliary virtual bones; and
associating the foreground object with the virtual skeleton according to a distribution of the plurality of body part blocks, thereby converting the foreground object into an avatar.

2. The avatar modeling method of claim 1, wherein in response to that the avatar is in motion, an avatar block corresponding to one body part block is configured to move or rotate as a single unit, and different avatar blocks corresponding to different body part blocks are configured to move or rotate relative to each other.

3. The avatar modeling method of claim 1, wherein the virtual skeleton comprises a virtual cervical vertebra located between a nose node and a chest node, and wherein the step of adding the plurality of auxiliary virtual bones comprises:
adding at least one first auxiliary virtual bone perpendicular to the virtual cervical vertebra.

4. The avatar modeling method of claim 3, wherein the virtual skeleton further comprises a first virtual shoulder blade located between a first shoulder node and the chest node, a second virtual shoulder blade located between a second shoulder node and the chest node, and a virtual spinal bone located between the chest node and a pelvis midpoint, and wherein the step of adding the plurality of auxiliary virtual bones further comprises:
adding a second auxiliary virtual bone connecting the first shoulder node and the pelvis midpoint; and
adding a third auxiliary virtual bone connecting the second shoulder node and the pelvis midpoint.

5. The avatar modeling method of claim 3, wherein the virtual skeleton further comprises a first virtual shoulder blade located between a first shoulder node and the chest node, a second virtual shoulder blade located between a second shoulder node and the chest node, a first virtual hip bone located between a first hip node and a pelvis midpoint, and a second virtual hip bone located between a second hip node and the pelvis midpoint, and wherein the step of adding the plurality of auxiliary virtual bones further comprises:
adding a fourth auxiliary virtual bone extending from the first hip node toward the first shoulder node; and
adding a fifth auxiliary virtual bone extending from the second hip node toward the second shoulder node.

6. The avatar modeling method of claim 5, wherein the plurality of auxiliary virtual bones are configured to facilitate a more precise segmentation of the plurality of body part blocks,
wherein the at least one first auxiliary virtual bone is configured to facilitate a correct segmentation of a head block and a neck block to prevent shape distortion of the neck block when the head block of the avatar is in motion, and
wherein the fourth auxiliary virtual bone and the fifth auxiliary virtual bone are configured to facilitate a correct segmentation of a torso block, a left arm block, and a right arm block to prevent shape distortion of the torso block when the left arm block or the right arm block of the avatar is in motion.

7. The avatar modeling method of claim 1, wherein the plurality of auxiliary virtual bones do not correspond to anatomical bones and are not any of the virtual bones within the virtual skeleton.

8. The avatar modeling method of claim 1, wherein the step of segmenting the foreground object into the plurality of body part blocks comprises:
defining a boundary of one of the plurality of body part blocks by expanding outward from a starting skeleton node until encountering another skeleton node of the virtual skeleton or one of the plurality of auxiliary virtual bones.

9. The avatar modeling method of claim 1, wherein, after the step of predicting the virtual skeleton, the avatar modeling method further comprising:
determining whether a pose of the virtual skeleton is correct based on a distribution of the plurality of skeleton nodes.

10. The avatar modeling method of claim 9, wherein the step of determining whether the pose of the virtual skeleton is correct comprises:
defining an upper body triangle and at least one lower body triangle based on the plurality of skeleton nodes;
determining whether the upper body triangle and the at least one lower body triangle overlap;
determining that the pose of the virtual skeleton is correct in response to the upper body triangle and the at least one lower body triangle not overlapping; and
determining that the pose of the virtual skeleton is incorrect in response to the upper body triangle and the at least one lower body triangle overlapping.

11. The avatar modeling method of claim 10, wherein the at least one lower body triangle comprises a first lower body triangle defined by a pelvis midpoint, a first knee node and a second knee node, and a second lower body triangle defined by the pelvis midpoint, a first ankle node and a second ankle node,
wherein the pose of the virtual skeleton is determined to be correct in response to the upper body triangle not overlapping with both of the first lower body triangle and the second lower body triangle, and
wherein the pose of the virtual skeleton is determined to be incorrect in response to the upper body triangle overlapping with either the first lower body triangle or the second lower body triangle.

12. The avatar modeling method of claim 9, wherein, in response to determining that the pose of the virtual skeleton is incorrect, the avatar modeling method further comprises:
executing a diffusion model to generate a modified foreground object based on the foreground object; and
predicting a plurality of modified skeleton nodes for the modified foreground object to generate a modified virtual skeleton.

13. The avatar modeling method of claim 12, wherein the diffusion model is configured to regenerate the modified foreground object to be human-like and to have a front-facing pose with arms naturally hanging down, based on the foreground object.

14. The avatar modeling method of claim 12, further comprising:
determining whether a pose of the modified virtual skeleton is correct based on a distribution of the plurality of modified skeleton nodes; and
in response to determining that the pose of the modified virtual skeleton is still incorrect, re-executing the diffusion model to generate another modified foreground object based on the foreground object.

15. An avatar modeling system, comprising:
a communication interface configured to receive an input image;
a storage unit configured to store an object detection model and a pose estimation model; and
a processor coupled to the communication interface and the storage unit, wherein the processor is configured to:
execute the object detection model to extract a foreground object from the input image;
execute the pose estimation model to predict a plurality of skeleton nodes for the foreground object to generate a virtual skeleton;
add a plurality of auxiliary virtual bones based on the plurality of skeleton nodes;
segment the foreground object into a plurality of body part blocks based on the virtual skeleton and the plurality of auxiliary virtual bones; and
associate the foreground object with the virtual skeleton according to a distribution of the plurality of body part blocks, thereby converting the foreground object into an avatar.

16. The avatar modeling system of claim 15, wherein the virtual skeleton comprises a virtual cervical vertebra located between a nose node and a chest node, a first virtual shoulder blade located between a first shoulder node and the chest node, a second virtual shoulder blade located between a second shoulder node and the chest node, a first virtual hip bone located between a first hip node and a pelvis midpoint, and a second virtual hip bone located between a second hip node and the pelvis midpoint, and wherein the processor is configured to:
add at least one first auxiliary virtual bone perpendicular to the virtual cervical vertebra;
add a second auxiliary virtual bone connecting the first shoulder node to the pelvis midpoint;
add a third auxiliary virtual bone connecting the second shoulder node to the pelvis midpoint;
add a fourth auxiliary virtual bone extending from the first hip node toward the first shoulder node; and
add a fifth auxiliary virtual bone extending from the second hip node toward the second shoulder node.

17. The avatar modeling system of claim 16, wherein the plurality of auxiliary virtual bones are configured to facilitate a more precise segmentation of the plurality of body part blocks,
wherein the at least one first auxiliary virtual bone is configured to facilitate a correct segmentation of a head block and a neck block to prevent shape distortion of the neck block when the head block of the avatar is in motion, and
wherein the second auxiliary virtual bone, the third auxiliary virtual bone, the fourth auxiliary virtual bone, and the fifth auxiliary virtual bone are configured to facilitate a correct segmentation of a torso block, a left arm block, and a right arm block to prevent shape distortion of the torso block when the left arm block or the right arm block of the avatar is in motion.

18. The avatar modeling system of claim 15, wherein after predicting the plurality of skeleton nodes for the foreground object to generate the virtual skeleton, the processor is further configured to:
determine whether a pose of the generated virtual skeleton is correct based on a distribution of the plurality of skeleton nodes.

19. The avatar modeling system of claim 18, wherein to determine whether the pose of the virtual skeleton is correct, the processor is further configured to:
define an upper body triangle and at least one lower body triangle based on the plurality of skeleton nodes;
determine whether the upper body triangle and the at least one lower body triangle overlap;
determine that the pose of the virtual skeleton is correct in response to the upper body triangle and the at least one lower body triangle not overlapping; and
determine that the pose of the virtual skeleton is incorrect in response to the upper body triangle and the at least one lower body triangle overlapping.

20. The avatar modeling system of claim 19, wherein in response to determining that the pose of the virtual skeleton is incorrect, the processor is further configured to:
execute a diffusion model to generate a modified foreground object based on the foreground object; and
predict a plurality of modified skeleton nodes for the modified foreground object to generate a modified virtual skeleton.
